(19) United States
(12) Patent Application Publication
(10) Pub. No.: US 2010/0196860 A1
(43) Pub. Date: Aug. 5, 2010

(54) AN EDUCATION AND ENTERTAINMENT APPARATUS

(76) Inventor: Jan Louise Donzow, Katherine (AU)

Correspondence Address: VAN DYKE, GARDNER, LINN & BURKHART, LLP, SUITE 207, 2851 CHARLEVOIX DRIVE, S.E., GRAND RAPIDS, MI, 49546, US

(21) Appl. No.: 12/602,188

(22) PCT Filed: Jun. 2, 2008
(86) PCT No.: PCT/AU2008/000792

§ 371 Date: Apr. 7, 2010

(30) Foreign Application Priority Data
Jun. 1, 2007 (AU) 2007902968

(51) Int. Cl. G09B 19/00; G09B 19/22; G09B 19/02; G09B 1/00; G09B 19/12

(52) U.S. Cl. 434/98; 434/128; 434/191; 434/159; 434/304; 434/167

(57) ABSTRACT

An educational tool for teaching a user, the tool including at least one first member having a plurality of different visual cues, at least one second member associated with the at least one first member, the at least one second member having a plurality of indicia, each indicia corresponding to at least one visual cue on the at least one first member, wherein indicia of the at least one second member are used in increasing levels of difficulty, to trigger the user to associate and identify indicia on the at least one second member with a corresponding visual cue on the at least one first member.

### FIELD OF THE INVENTION

The present invention relates to a tool used for education and entertainment.

### BACKGROUND ART

The use of tools of a wide variety of designs and configurations for education is well known in the prior art. However, generally these tools are books, drawing materials, solid toys or computer games. Many of these tools are for solitary use and do not assist in teaching interpersonal relationship skills. In addition, these tools can take up a lot of storage space and are often expensive. Hence, it can be appreciated that there exists a continuing need for new and improved tools for education which involve human interaction, and are compact and inexpensive.

Moreover, some parents with low literacy skills find it uncomfortable or embarrassing to read to their child or in front of other people. In addition, many learning aids are directed towards a single topic.

The use of tools of a wide variety of designs and configurations for entertainment is known in the prior art. Generally, however, these tools are developed for specific and limited age ranges. These tools are therefore of limited entertainment value to persons who fall outside those age ranges. Hence, it can be appreciated that there exists a continuing need for new and improved tools for entertainment, which have been developed for entertainment of persons of all ages, from infancy to adulthood.

Many of the tools used for entertainment known in the prior art are board games. For the purpose of storage, these board games often have a fold down the centre of two halves. This fold often splits after recurring use of the game over time. Therefore, it can be appreciated that there exists a continuing need for new and improved boards, which can withstand use over time.

Further, educational tools which are adapted to be used as games are less common in the art. Although many games need to be learned prior to or as they are played, making them at least partially educational in nature, there are few games which can be used to teach core skills to young children such as reading, writing and other basic knowledge sets.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a tool, which may at least partially overcome at least one of the abovementioned disadvantages or provide the consumer with a useful or commercial choice.

In one broad form, the invention resides in a tool for teaching basic knowledge sets including alphabet, numbers, colours and shapes and for entertainment, comprising, in combination, at least one first member and at least one second member that associates with the at least one first member.

In one more particular form, the invention resides in an educational tool for teaching a user, the tool including:
a) At least one first member having a plurality of different visual cues;
b) At least one second member associated with the at least one first member, the at least one second member having a plurality of indicia, each indicia corresponding to at least one visual cue on the at least one first member;
   Wherein indicia of the at least one second member are used in increasing levels of difficulty, to trigger the user to associate and identify indicia on the at least one second member with a corresponding visual cue on the at least one first member.

The at least one first member may be stiff or flexible. The at least one first member is preferably made of light weight wood. In another embodiment it may be plastic. The at least one first member is preferably a board or similar. In another embodiment it may be a mat. The at least one first member is preferably a rectangular shape but of course may be round, oval or any other suitable shape.

The at least one first member may be shaped, having a raised surface or profile but is preferably a planar member. The at least one first member preferably has two planar surfaces. Either planar surface may be oriented upwards in use. Each planar surface is preferably colourful but may be monotone or black and white. Each planar surface will preferably differ. In a preferred embodiment, one planar surface may have letters and primary colours and the other planar surface may have numbers and secondary colours.

In its preferred embodiment the at least one first member will have visual cues. These visual cues may consist of shapes, pictures letters or numbers for example. Preferably the visual clues are located in a first group in a band located adjacent to and extending around the periphery (usually in a configuration similar to conventional board games), and in a second group located between the at least one second member and the pictures around the periphery. These pictures may be of animals, plants and inanimate objects from nature, or of any other thing.

The at least one first member will preferably be adapted to sit on a support surface such as a table. However, the at least one first member may be adapted to hang on a wall or may be adapted to lie on the floor. The at least one first member may consist of one or more pieces as this may allow size reduction of the first member to allow for storage, transport or similar. Where the at least one first member consists of more than one piece, each piece is preferably equal in size.

The one or more pieces may each have at least one indentation, typically in the form of an opening or depression on or in one or both of the planar surfaces. Where a depression is provided, the depression may have a central member provided with the intent of positively locating the at least one second member relative to the depression. Where a single piece board is provided, a single indentation will typically be provided approximately centrally in the board, but where a multi-piece board is provided, the indentations may be equally placed on each piece and will generally be placed near the edge of each piece, preferably 5 cm from the edge of each piece, such that when the pieces are positioned correctly in use and aligned, the indentations are also aligned creating a single indentation into which the at least one second member is located.

There may also be one or more openings in the first pieces, typically used to attach or position the tool relative to a surface or so that the pieces can be properly located relative to each other and typically temporarily attached relative to each other so that the pieces do not accidentally move during use. The openings are normally provided spaced from the edges of the pieces.

The first pieces may be hung from a wall by screws or any other apparatus. These screws or any other apparatus may fit into indentations near the edge of each piece.

The pieces may be connected by means of an engagement plate. Where provided and used, the engagement plate will preferably have a planar underside with one or more (normally a pair of spaced apart) projections on or from the top surface of the plate. Each of the projections may fit into one of the indentations near the edge of each piece. The engagement plate may be made of rubber or any other suitable material. Preferably the material will be at least slightly resilient in order to be soft to adapt it for use with younger children.

Each indentation in each piece of the at least one first member may be placed near the centre of the piece. Other components that the tool may have in addition to the at least one first member and the at least one second member, such as hour and minute hands may have projections which fit into the indentations near the centre of the at least one first member. The at least one second member may fit into the indentions near the centre of the at least one first member.

The at least one second member may be stiff or flexible. The at least one second member is preferably made of light weight wood, or cardboard. In another embodiment it may be plastic. The at least one second member is preferably a board. In another embodiment it may be a mat. The at least one second member is preferably an oval shape but may be triangular or square or any other shape.

The at least one second member is preferably a planar member. The at least one second member preferably has two planar surfaces, an upper and a lower surface. Either planar surface may be oriented upwards. Each planar surface is preferably colourful but may be monotone or black and white. Each planar surface will preferably differ. In its preferred embodiment the at least one second member will have indicia around the periphery, but the indicia may be anywhere on the at least one second member. In its preferred embodiment the indicia on at least one planar surface will be letters and the indicia on the other planar surface will be numbers. The at least one second member is adapted to be used with either surface facing upward and swapping the surface in use will typically change the functionality of the at least one second member.

Preferably the at least one second member will be an island portion. The at least one second member will preferably be adapted to fit into an indentation near the centre of the at least one first member. When in position in the indentation near the centre of the at least one first member, the uppermost surface of the at least one second member will preferably be flush with the upper surface of the at least one first member. The at least one second member is preferably positioned in the centre of the at least one first member but may be positioned in any other location in relation to the at least one first member as its functionality is not affected by the position of the at least one second member only its accessibility. The at least one second member may be manipulated (in order to be placed in and removed from the indentations near the centre of the at least one first member) by gripping means such as at least one opening through the at least one second member, or an indentation in the at least one second member or a handle on the at least one second member. Alternatively, the at least one second member may be adapted to hang on a wall or may be adapted to lie on the floor.

In addition to the at least one first member and the at least one second member, the tool may have cards, including colour cards, shape cards, number cards, maths sign cards and alphabet cards; tokens, including tokens of different colours and shapes; chips; instruction cards, including cards of different colours; consignment cards; rules; dice; hour and minute hands and any other component which adapts the tool for teaching or entertainment. In a preferred embodiment, there will be 8 colour cards, 8 shape cards, 26 number cards, 8 maths sign cards and 26 alphabet cards; 10 tokens in the shape of a boat, canoe or any other vehicle for locomotion or any other object; 10 tokens in the shape of a button, or with a circular shape or any other shape; 60 chips; 26 instructions cards in red, green, blue and purple or any other colours; 26 consignment cards with alphabet information and facts about animals; 26 consignment cards with number information and facts about humans; 26 consignment cards with alphabet and number information and facts about animal myths or animal extinction; 2 dice; one hour hand and one minute hand.

In another narrower form the invention resides in a method of teaching a user increasing levels of difficulty including the steps of:
a) Providing an educational tool for teaching a user, the tool including at least one first member having a plurality of different visual cues and at least one second member associated with the at least one first member, the at least one second member having a plurality of indicia, each indicia corresponding to at least one visual cue on the at least one first member;
b) Using the at least one second member to trigger the user to associate indicia on the at least one second member with a corresponding visual cue on the at least one first member.

In its preferred embodiment the tool will have a number of shape cards. Each shape card will have one shape on the face of the card. Each shape will typically be represented at least once on the at least one first member. The first level of difficulty is preferably teaching the user to find and name shapes on the at least one first member that match the shape on the face of a selected shape card. The user may also be required to identify the required shape by vocalisation or indication.

In a preferred embodiment the tool will have a number of colour cards. Each colour card will have one colour on the face of the card and that colour will also typically be represented on the at least one first member at least once. The second level of difficulty is preferably teaching the user to find and name colours on the at least one first member that match the colour on the face of a selected colour card. The user may also be required to identify the required colour by vocalisation or indication.

The third level of difficulty is preferably teaching the user to find and name colours on the at least one first member that are created by a combination of the colours on the faces of two or more selected colour cards. The user may also be required to identify the required colour by vocalisation or indication.

In a preferred embodiment the tool will have a number of alphabet cards. Each alphabet card will have at least one and typically only one letter on the face of the card and that letter will also typically be represented on the at least one first member at least once. The fourth level of difficulty is preferably teaching the user to find and name the letter on the at least one second member that matches the letter on the face of a selected alphabet card. The user may also be required to identify the required letter by vocalisation or indication.

The fifth level of difficulty is preferably teaching the user to find and name a picture or image on the at least one first member where the first letter in the name of the object of the picture or image on the at least one first member matches the letter on the face of a selected alphabet card.

In a preferred embodiment the tool will have a number of “number” cards. Each number card will typically have at least one and preferably only one number on the face of the card and that number will also typically be represented on the at least one first member, normally through groups of images or images of groups of objects. In an alternative embodiment, an upper approximately half of the card may have a number symbol and one or more images to assist with the identification of the number, namely that the number of images represented equals the number represented. A lower approximately half of the card will preferably have a word printed thereon and a number of images. The sixth level of difficulty is preferably teaching the user to identify the number of a particular type of thing that the tool may have in addition to the at least one first member and the at least one second member (such as the number of tokens) that matches the number on the face of a selected number card; and preferably teaching the user to identify the number of a particular visual cue that appears on the at least on first member that matches the number on the face of a selected number card.

The seventh level of difficulty is preferably teaching the user to name all of the numbers on the number cards and to put the number cards in ascending or descending order.

In a preferred embodiment, the at least one first member will have a number of compass points or a compass rose on at least one of the planar surfaces. The eighth level of difficulty is preferably teaching the user to identify the compass points. Cards may be provided to prompt the identification of the compass points. Direction cards preferably accommodate the use of map insert or compass insert into the main board. An approximately upper half of the direction card typically includes an animal's country of origin. The approximately bottom half of the card identifies where the picture of the animal is on the frame, e.g. “A hippopotamus is pictured in the northeast corner of the frame”. North, south, east and west are preferably indicated in the form of a sunset, a sunrise, the northern lights and the southern lights.

The ninth level of difficulty is preferably teaching the user to name the direction of the compass points.

In a preferred embodiment the tool will have a number of maths sign or symbol cards. The tenth level of difficulty is preferably teaching the user to find a maths card and use the maths card in combination with other cards and/or the first or second members to trigger mathematical combinations.

The eleventh level of difficulty is preferably teaching the user to perform mathematical calculations created by two or more selected number cards and one or more selected maths sign cards. Tokens or chips may be used to assist with the mathematical calculations.

In a preferred embodiment, the at least one first member will have a clock face on at least one of the planar surfaces. This clock face will preferably have an indentation at the centre. The hour and minute hands have projections which fit into the indentation. Alternatively, the clock face will preferably have an elongate member at the centre and the hour and minute hands have an opening which fits onto the elongate member. This configuration is also preferably used for the compass needle. The hands can be rotated 360 degrees to set the clock face on at least one of the planar surfaces to any time of day. The twelfth level of difficulty is preferably teaching the user to name the time indicated by the hour and minute hands using one or more prompt cards to identify a time to be set. Other more complex time display means may be used such as a digital display with time, day, date, year, decade and/or century.

In a preferred embodiment, the tool will have a number of consignment cards. The thirteenth level of difficulty is preferably teaching the user to relate the time indicated by the hour and minute hands on the clock face to periods of time indicated on some of the consignment cards (including: month, year, decade and century).

In a preferred embodiment the tool will have a number of chance cards. The face of each chance card will typically have a picture of an animal surrounded by a number of words. The fourteenth level of difficulty is preferably teaching the user to select the descriptive words from the number of words surrounding the animal on the face of a selected chance card. Typically each of the group of words in the card will begin with the same letter as the animal represented on the card.

The fifteenth level of difficulty is preferably teaching the user to look up the descriptive words (identified from the number of words surrounding the animal on the face of the selected chance card) in a dictionary and thesaurus.

The levels of difficulty (or skill units) may be taught in a graduated manner with a user required to master one level prior to progressing to the next level. The skill units may alternatively be used in any order. The skill units may also be used to identify the developmental level of the user in an evaluation mode where the user is subjected to the skill units in either forward or reverse order until all are complete or until a user cannot perform a skill unit.

The representations of objects may alternatively be provided on one or more second members and the second members may be removable and replaceable with different second members in order to tailor the teaching to the particular skill unit to be taught.

According to an embodiment, the consignment cards may be replaced with “alphabet” cards. The alphabet cards typically include a letter and an image of an object whose name begins with that letter. The alphabet cards may also carry an alliterative sentence to trigger or increase retention.

In another narrower form the invention resides in a method of playing a game including the steps of:
a) Providing a tool for entertainment of a user, the tool including at least one first member having a plurality of different visual cues and at least one second member associated with the at least one first member, the at least one second member having a plurality of indicia, each indicia corresponding to at least one visual cue on the at least one first member;
b) Using the at least one second member to trigger the user to associate indicia on the at least one second member with a corresponding visual cue on the at least one first member.

One embodiment of the present invention comprises a board game for children aged 2 and older. The first player must pick a card and match it to one of the pictures (of fish or any other thing) between the island or at least one second piece and the pictures or representations around the periphery of the at least one first piece.

An alternate embodiment of the present invention comprises a board game for children aged 4 and older. According to this preferred embodiment two players may play at one time. All of the numerical and alphabetical cards are shuffled together. The cards are then dealt to both players, one at a time, face down, until all are cards are dealt. Both players will have a stack of cards. In unison, the players both place one of their cards from the stack, face up, in a separate pile on the board. When the numbers or letters on the face of the cards on top of the piles match, the players vocalise “snap”. The first player to correctly vocalise the word “snap” or similar term takes both piles of cards from the board and keeps them in a separate pile. The winner is the player with the most cards in their separate pile after both players have used all of the cards from their original stack of cards.

An alternate embodiment of the present invention comprises a board game for children aged 4 and older. All of the tokens are shuffled and are placed face down on the board. In turns, each player turns two tokens over (so they are face up). If the two tokens match, the player keeps the tokens. If the two tokens do not match, the player turns the tokens face down again, leaving them in their original position on the board before the next player has their turn. The winner is the player with the most pairs of tokens after there are no tokens left in their original position on the board.

An alternate embodiment of the present invention comprises a board game for children aged 5 and older. The players preferably decide whether the numerical or alphabetical side of the removable island is placed oriented upwards in the centre of the board. All of the numerical and alphabetical cards are shuffled together. Each player is dealt, face down, five cards from the pack of shuffled cards. Each player may look at their own cards and discard any cards that do not match the numbers or letters on the removable island. Each player is then given, from the pack of shuffled cards, the same number of cards that they discarded. This process only happens once. Each player then places on the board, face up, all cards that match the numbers or letters on the removable island. The winner is the player with the least number of cards left in their hand.

An alternate embodiment of the present invention comprises a board game for persons aged from 6 to adult. According to this embodiment, the players select which side of the board to place oriented upwards, which side of the removable island to place oriented upwards and which set of consignment cards to use. Each player selects a consignment card from the pile. The players compare the alphabetical order of the animals on the respective consignment cards they selected. The player with the animal on the consignment card that is last in alphabetical order, goes first. All other players take turns in clockwise order. All of the consignment cards are then returned to the pile.

In turn, players roll the two dice and move across a corresponding number of squares, clockwise around the board (beginning at the start line). When landing on a yellow marking, the players draw a “tale” card which includes a short story, alliterative sentence with an element of truth or anecdote about an animal. When landing on a green marking, players draw a “trail” card which includes a short story or anecdote about an animal. Landing on any other coloured marking requires the player to pick up a consignment card of the corresponding colour and carry out the instructions on the card. Such instructions might be to give something up, to take something, to move in a specific direction or to return to an animal depicted on the consignment card.

Landing on a North/South compass point requires the player to roll one dice and move back corresponding number of squares. Landing on an East/West compass point requires the player to roll one dice and move forward corresponding number of squares.

A player may not have any more than two turns in a row (moves instructed by a consignment card are the last moves that can be made by any player during the current turn). The object of the game is for each player to collect the four items (boat, food, binoculars and hat) depicted on the consignment cards. Once all items have been collected, players must leave their token on “land”, namely leave it on the animal from which they left, and use their boat to cross the “water”, namely the part of the board between the pictures around the periphery and the removable island portion, to get to the finish line. Any player who forgets to leave their token on the square on the periphery of the board from where they left before moving their boat token across the part of the board between the pictures around the periphery and the removable island portion must return to a square on the periphery of the board containing an animal of their choice. The winner is the first to successfully leave their token on “land” and use their boat to cross the “water” to get to the finish line.

An example of the skill units, their specific topic, the insert or second member used in teaching that skill unit, cards and recommended age of user are contained in Table 1:

Shared knowledge units

| | | | | Recommended |
|---|---|---|---|---|
| SKU | TOPIC | INSERT | CARDS | age |
| 1 | colours | Shapes & | colour | 3-4 |
| | | colours | | |
| 2 | shapes | Shapes & | shape | 3-4 |
| | | colours | | |
| 3 | numbers | Numerical | numbers | 4-6 |
| | | sequence | | |
| 4 | alphabet | Alphabet | alphabet | 4-6 |
| | | sequence | | |
| 5 | Word structure | Alphabet | animal tales - | 6+ |
| | | sequence | from board | |
| | | | game | |
| 6 | Simple sums | Numerical | Math symbols | 6+ |
| | | sequence | Counters - | |
| | | | from board | |
| | | | game | |
| 7 | direction | Compass + | Animal fact - | 6+ |
| | | map | location/frame | |
| | | | direction | |
| 8 | time | clock | Animal fact - | 6+ |
| | | | newsflash | |
| 9 | measurement | Measurement | Animal fact - | 6+ |
| | | type | measurement | |

An example of the various games which can be played using the device as hereinbefore described is as follows:

Games

| | | | | Recom- |
|---|---|---|---|---|
| | | | | mended |
| Name | items | INSERT | CARDS | age |
| Where is it? | | Arajii animal | Shapes and | 3-4 |
| | | reserve | colours | Two players |
| Snap | | Arajii animal | Numbers and | 5-8 |
| | | reserve | alphabet | Two-four |
| | | | | players |
| Go Fish | | Arajii animal | Numbers and | Two + four |
| | | reserve | alphabet | players |
| Lonely lion | | Arajii animal | Numbers and | Two + four |
| | | reserve | alphabet | players |
| King of the | | Arajii animal | Numbers and | 8 + |
| jungle | | reserve | alphabet | Two-six |
| | | | | players |
| Animal | | Arajii animal | alphabet | 8 + |
| charades | | reserve | | Two-26 |
| | | | | players |
| Arajii animal | 48 x item | Arajii animal | Alphabet | 8 + |
| reserve | tokens | reserve | animal trails | Two-six |
| | 6 x player | | animal tales | players |
| | tokens | | | |
| | 6 x canoe | | | |
| | tokens | | | |
| | 2 dice | | | |
| memory | 4 x water | Arajii animal | | 6 + |
| | tokens | reserve | | Two players |
| | 4 x camera | | | |
| | tokens | | | |
| | 4 x hat tokens | | | |
| | 4 x stone | | | |
| | tokens | | | |

### BRIEF DESCRIPTION OF THE DRAWINGS

Various embodiments of the invention will be described with reference to the following drawings, in which:

FIG. 1 is a schematic view from above of a board with island portion removed according to a preferred embodiment;

FIG. 2 is a schematic view from above of a board with island portion in place, set up to play the Araji animal reserve game, according to a preferred embodiment;

FIG. 3 is a schematic view from above of one planar surface of a board with island portion in place, said planar surface featuring letters and primary colours, according to a preferred embodiment;

FIG. 4 is a schematic view from above of one planar surface of a board with island portion in place, said planar surface featuring numbers and secondary colours, according to a preferred embodiment;

FIG. 5 is a view of the face of a colour card according to a preferred embodiment;

FIG. 6 is a view of the face of a number card according to a preferred embodiment;

FIG. 7 is a view of the face of a shape card according to a preferred embodiment;

FIG. 8 is a view of the face of an alphabet card according to a preferred embodiment;

FIG. 9 is a view of the chips according to a preferred embodiment;

FIG. 10 is a view of the things other than the at least one first member and the at least one second member that the tool may have, including dice tokens and chips, according to a preferred embodiment;

FIG. 11 is a view of the face and back of an instruction card according to a preferred embodiment;

FIG. 12 is a view of the face of a consignment card according to a preferred embodiment;

FIG. 13 is a view of the back of an alphabet, number shape or colour card, according to a preferred embodiment;

FIG. 14 is a view of the back of a consignment card, according to a preferred embodiment;

FIG. 15 is a schematic view from above of two equal size pieces of a planar board with indentations near the periphery of the board according to a preferred embodiment;

FIG. 16 is a schematic view from above of a removable mould according to a preferred embodiment;

FIG. 17 is a side view of a removable mould with two projections on the superior surface according to a preferred embodiment;

FIG. 18 is a schematic view from above of the two equal size pieces of a planar board held together by the removable mould (such removable mould sitting under the board with the projections on the superior surface fitting into the indentations near the periphery of the board), according to a preferred embodiment.

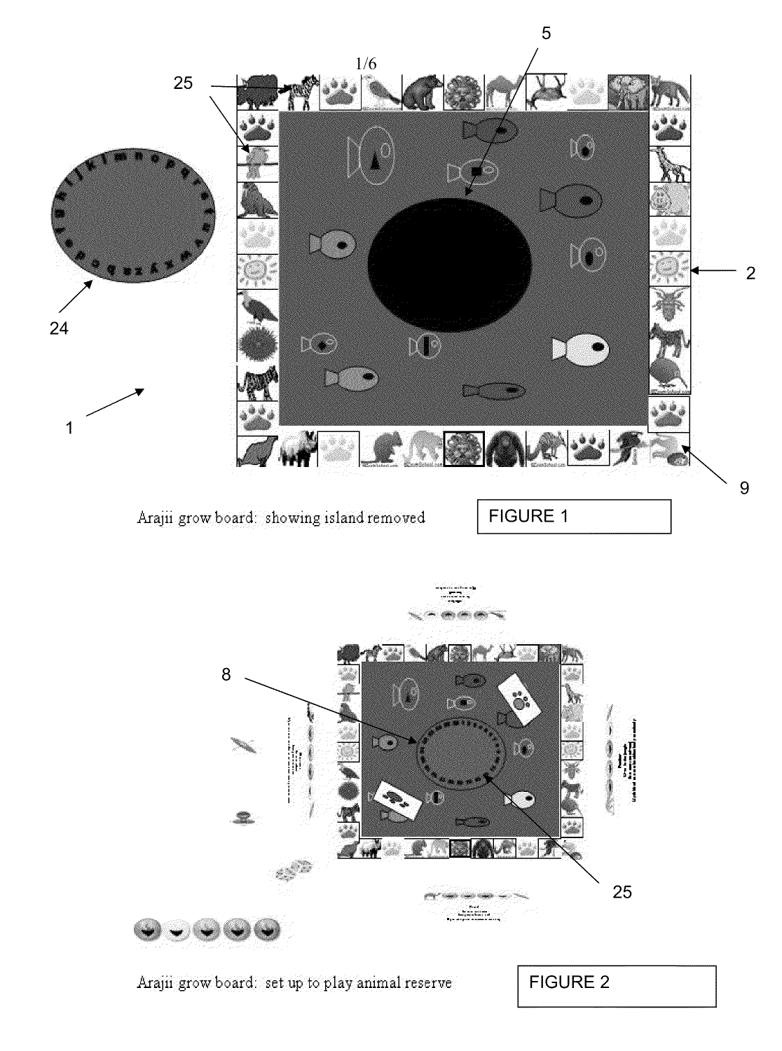

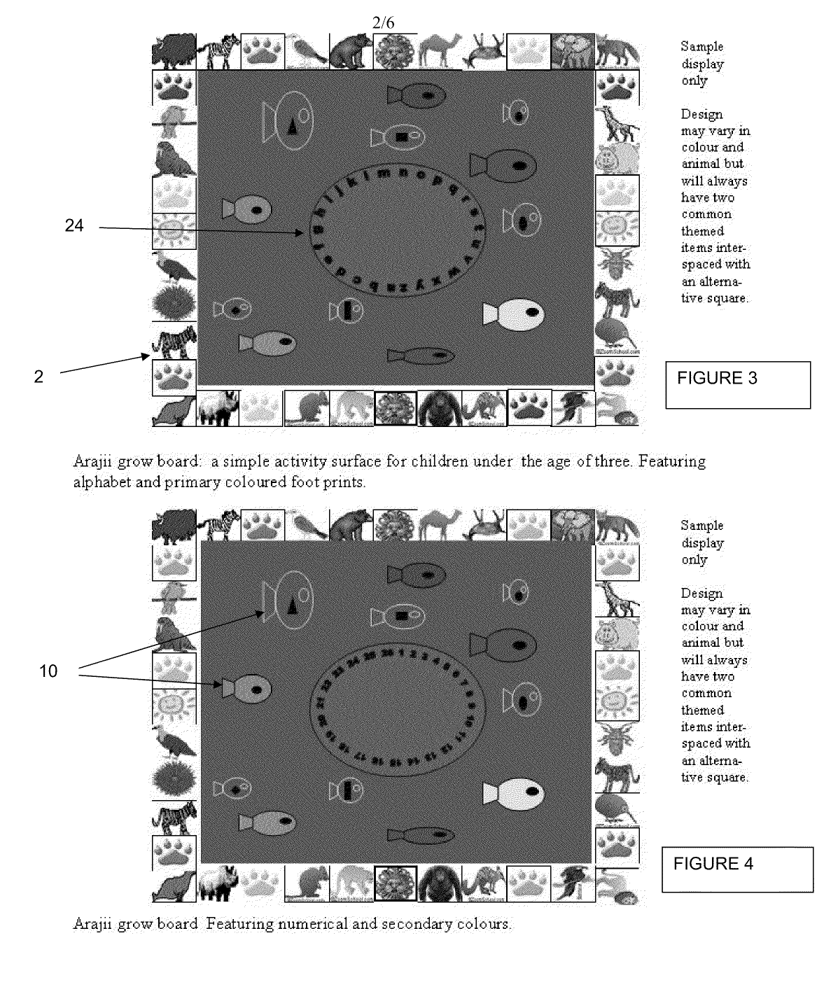

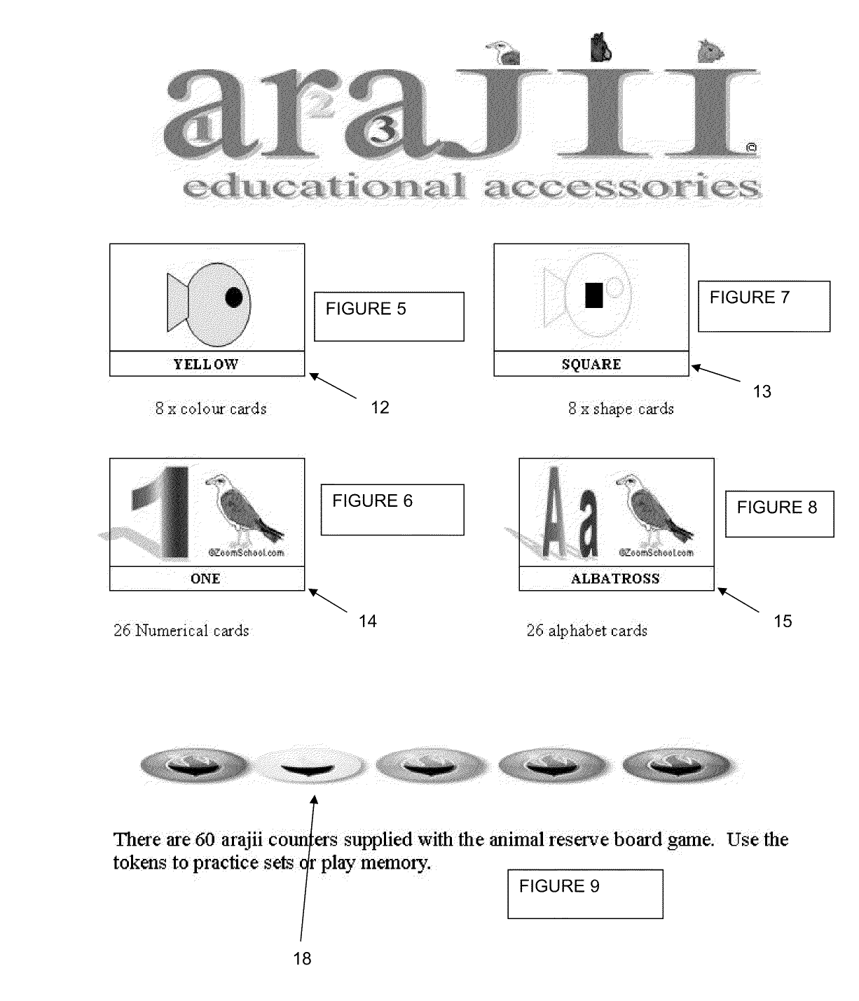

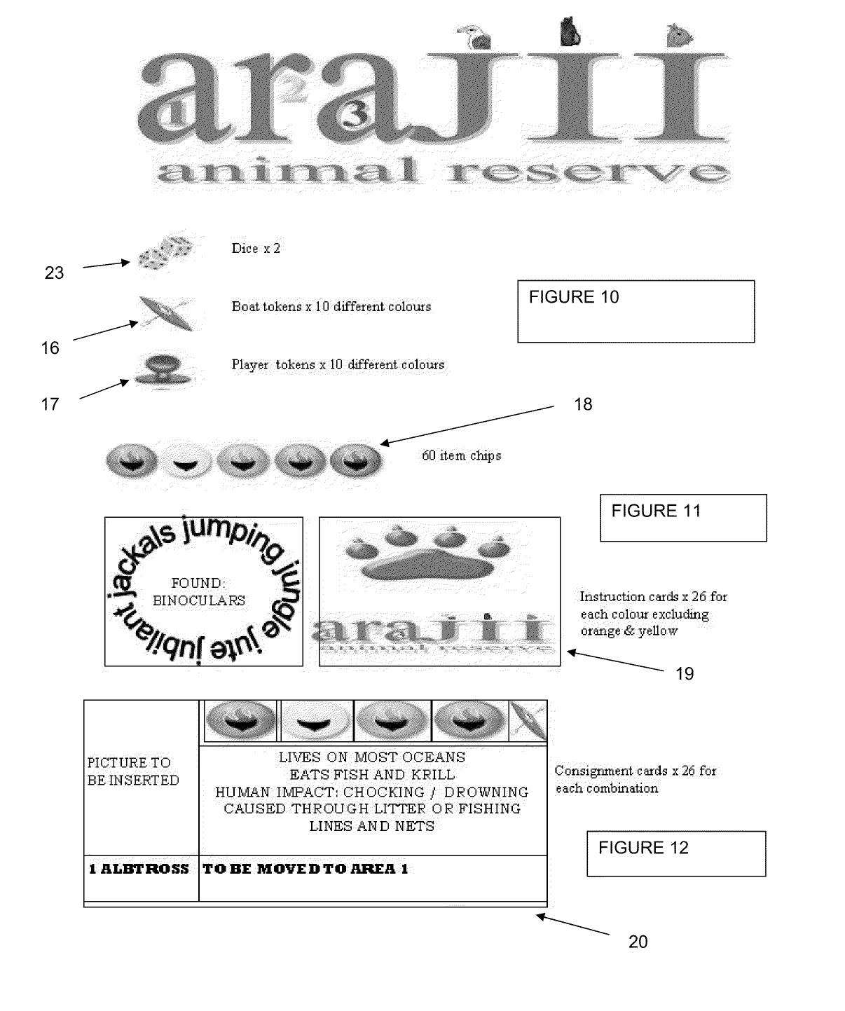

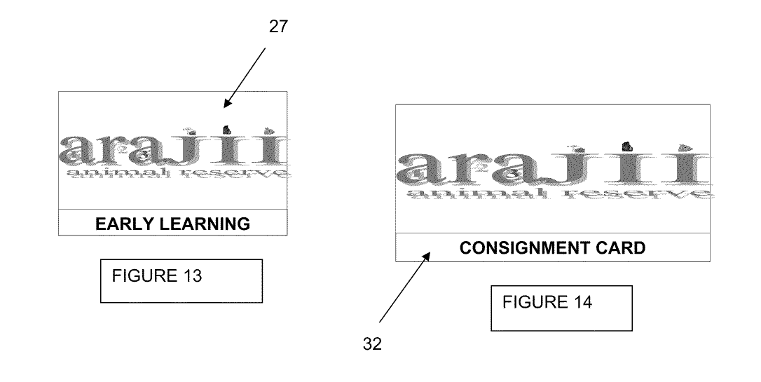

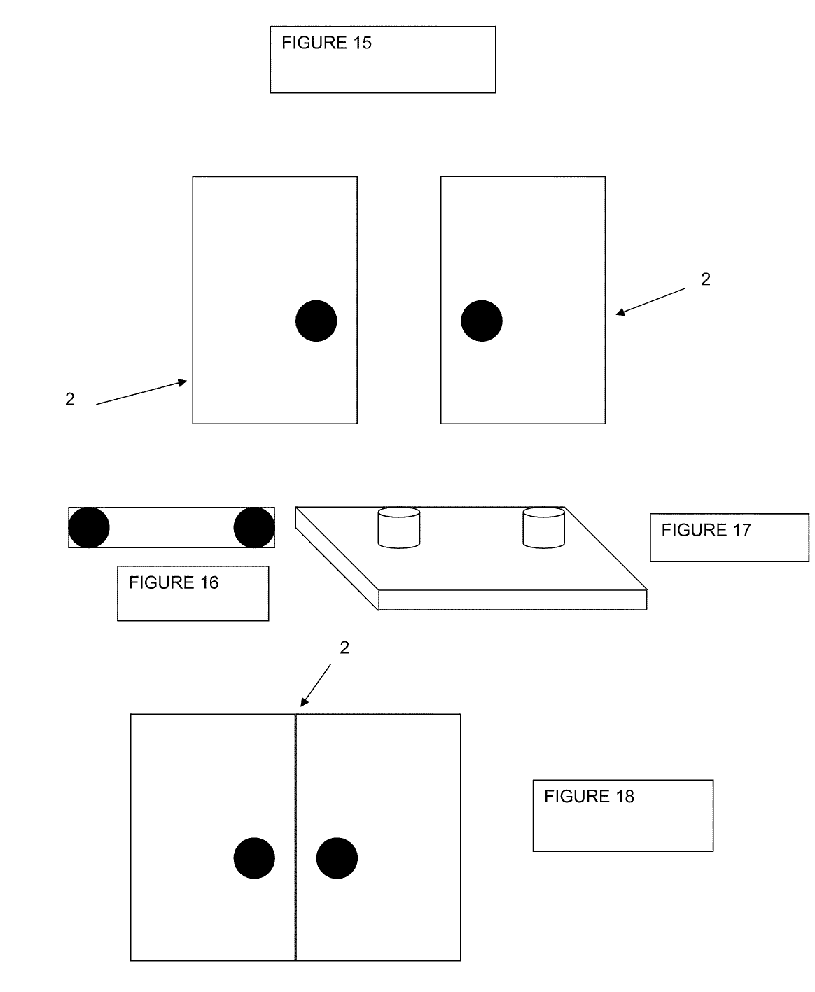

### DETAILED DESCRIPTION OF THE PREFERRED EMBODIMENT

The invention is a tool designated by the reference numeral 1. As shown in the various figures, the primary embodiment of the present invention is a tool 1 formed of a plurality of components. In their broadest context, such components simply include at least one first member and at least one second member. The components are individually configured and correlated with each other for education and entertainment.

The central component of this tool 1 is the at least one first member 2. The at least one first member has a superior planar surface 3 and an inferior planar surface 4. The at least one first member 2 has an indentation 5 at its central interior. Both planar surfaces 3 and 4 of the board 2 have pictures 25 around the periphery 9. Both sides 3 and 4 of the board 2 have pictures 10 between the indentation 5 and the pictures 25 around the periphery 9.

The at least one second member 24 may fit into the indentation 5. The at least one second member 24 has a superior planar surface 6 and an inferior planar surface 7. Both planar surfaces 6 and 7 of the at least one second member 24 have indicia 25 around the circumference 8 of the at least one second member 24.

Next provided is the accessories 11. The accessories 11 include 8 colour cards 12, 8 shape cards 13, 26 number cards 14 and 26 alphabet cards 15; 10 tokens in the shape of a boat 16; 10 tokens in the shape of a button 17; 60 chips 18; 26 instructions cards in red, green, blue and purple 19; 26 consignment cards with alphabet information and facts about animals 20; 26 consignment cards with number information and facts about humans 21; 26 consignment cards with alphabet and number information and facts about animal myths or animal extinction 22; two dice 23. The colour cards 12 have a face 26 and a back 27; the shape cards 13 have a face 28 and a back 27; the number cards 14 have a face 29 and a back 27; the alphabet cards 15 have a face 30 and a back 27. The consignment cards 21,21,22 have a face 31 and a back 32. The instruction cards 19 have a face 33 and a back 34.

In its preferred embodiment the tool will have a number of shape cards. Each shape card will have one shape on the face of the card. The first level of difficulty is preferably teaching the user to find and name shapes on the at least one first member that match the shape on the face of a selected shape card.

In its preferred embodiment the tool will have a number of colour cards. Each colour card will have one colour on the face of the card. The second level of difficulty is preferably teaching the user to find and name colours on the at least one first member that match the colour on the face of a selected colour card.

The third level of difficulty is preferably teaching the user to find and name colours on the at least one first member that are created by combination of the colours on the faces of two or more selected colour cards.

In its preferred embodiment the tool will have a number of alphabet cards. Each alphabet card will have one letter on the face of the card. The fourth level of difficulty is preferably teaching the user to find and name the letter or letters on the at least one second member that match the letter on the face of a selected alphabet card.

The fifth level of difficulty is preferably teaching the user to find and name a picture on the at least one first member where the first letter in the name of the picture on the at least one first member matches the letter on the face of a selected alphabet card.

In its preferred embodiment the tool will have a number of number cards. Each number card will have one number on the face of the card. The sixth level of difficulty is preferably teaching the user to identify the number of a particular type of thing that the tool may have in addition to the at least one first member and the at least one second member (such as the number of tokens) that matches the number on the face of a selected number card; and is preferably teaching the user to identify the number of a particular visual cue that appears on the at least on first member that matches the number on the face of a selected number card.

The seventh level of difficulty is preferably teaching the user to name all of the numbers on the number cards and to put the number cards in ascending or descending order.

In its preferred embodiment the at least one first member will have a number of compass points on at least one of the planar surfaces. The eighth level of difficulty is preferably teaching the user to identify the compass points.

The ninth level of difficulty is preferably teaching the user to name the direction of the compass points.

In its preferred embodiment the tool will have a number of maths sign cards. In its preferred embodiment the at least one first member will have a number of maths signs on at least one of the planar surfaces. The tenth level of difficulty is preferably teaching the user to find and name the maths sign on the at least one first member that matches the maths sign on the face of a selected maths sign card.

The eleventh level of difficulty is preferably teaching the user to perform mathematical calculations created by two or more selected number cards and one or more selected maths sign card. Tokens or chips make be used to assist with the mathematical calculations.

In its preferred embodiment the at least one first member will have a clock face on at least one of the planar surfaces. This clock face will have an indention at the centre. The hour and minute hands have projections which fit into the indention. The hands can be rotated 360 degrees to set the clock face on at least one of the planar surfaces to any time of day. The twelfth level of difficulty is preferably teaching the user to name the time indicated by the hour and minute hands.

In its preferred embodiment, the tool will have a number of consignment cards. The thirteenth level of difficulty is preferably teaching the user to relate the time indicated by the hour and minute hands on the clock face to periods of time indicated on some of the consignment cards (including: month, year, decade and century).

In its preferred embodiment the tool will have a number of chance cards. The face of each chance card will have a picture of an animal surrounded by a number of words. The fourteenth level of difficulty is preferably teaching the user to select the descriptive words from the number of words surrounding the animal on the face of a selected chance card.

The fifteenth level of difficulty is preferably teaching the user to look up the descriptive words (identified from the number of words surrounding the animal on the face of the selected chance card) in the dictionary and thesaurus.

One embodiment of the present invention comprises a board game for children aged 2 and older. The first player must pick a card and match it to one of the pictures (of fish or any other thing) between the island and the pictures around the periphery.

An alternate embodiment of the present invention comprises a board game for children aged 4 and older. Two players may play at one time. All of the numerical and alphabetical cards are shuffled together. The cards are then dealt to both players, one at a time, face down, until all are cards are dealt. Both players will have a stack of cards. In unison, the players both place one of their cards from the stack, face up, in a separate pile on the board. When the numbers or letters on the face of the cards on top of the piles match, the players yell snap. The first player to correctly yell snap takes both piles of cards from the board and keeps them in a separate pile. The winner is the player with the most cards in their separate pile after both players have used all of the cards from their original stack of cards.

An alternate embodiment of the present invention comprises a board game for children aged 4 and older. All of the tokens are shuffled and are placed face down on the board. In turns, each player turns two tokens over. If the two tokens match, the player keeps the tokens. If the two tokens do not match, the player turns the tokens face down again, leaving them in their original position on the board before the next player has their turn. The winner is the player with the most pairs of tokens after there are no tokens left face down on the board.

An alternate embodiment of the present invention comprises a board game for children aged 5 and older. The players will decide whether the numerical or alphabetical side of the removable island is placed face up in the centre of the board. All of the numerical and alphabetical cards are shuffled together. Each player is dealt, face down, five cards from the pack of shuffled cards. Each player may look at their own cards and discard any cards that do not match the numbers or letters on the removable island. Each player is then given, from the pack of shuffled cards, the same number of cards that they discarded. This process only happens once. Each player then places on the board, face up, all cards that match the numbers or letters on the removable island. The winner is the player with the least number of cards left in their hand.

An alternate embodiment of the present invention comprises a board game for persons aged from 6 to adult. The players select which side of the board to place face up, which side of the removable island to place face up and which set of consignment cards to use. Each player selects a consignment card from the pile. The players compare the alphabetical order of the animals on the consignment cards they selected. The player with the animal on the consignment card that is last in alphabetical order, goes first. All other players take turns in clockwise order. All of the consignment cards are then returned to the pile.

In turn, players roll the two dice and move across a corresponding number of squares, clockwise around the board. Players may choose to miss a turn when landing on a yellow paw. When landing on a yellow or orange paw print players they have the option of calling “sore paw”, collecting a used paw card and rapidly quoting the words around the boarder three times, or as many times as otherwise decided by the players or by the parents or guardians of the players (depending on the age of the people playing the game). This gives the player a free step. Free steps can be used to move one square forward or back as desired. Landing on any other coloured paw print requires the player to pick up a consignment card of the corresponding colour and carry out the instructions on the card. Such instructions might be to give something up, to take something, to move in a specific direction or to return to an animal depicted on the consignment card.

Landing on a North South compass point requires the player to roll one dice and move back corresponding number of squares. Landing on an East West compass point requires the player to roll one dice and move forward corresponding number of squares.

A player may not have any more than two turns in a row (moves instructed by a consignment card are the last moves that can be made by any player during the current turn). The object of the game is for each player to collect the four items (boat, food, binoculars and hat) depicted on the consignment cards. Once all items have been collected, players must leave their token on “land”, namely leave it on the animal from which they left, and use their boat to cross the “water”, namely the part of the board between the pictures around the periphery and the removable island. Any player who forgets to leave their token on the square on the periphery of the board from where they left must return to a square on the periphery of the board containing an animal of their choice.

According to a preferred embodiment of the present invention the shared knowledge units and the method of teaching these units using the device, are as follows:

Shared knowledge units

| | | | | Recommended |
|---|---|---|---|---|
| SKU | TOPIC | INSERT | CARDS | age |
| 1 | colours | Shapes & | colour | 3-4 |
| | | colours | | |
| 2 | shapes | Shapes & | shape | 3-4 |
| | | colours | | |
| 3 | numbers | Numerical | numbers | 4-6 |
| | | sequence | | |
| 4 | alphabet | Alphabet | alphabet | 4-6 |
| | | sequence | | |
| 5 | Word | Alphabet | animal tales - | 6+ |
| | structure | sequence | from board | |
| | | | game | |
| 6 | Simple sums | Numerical | Math symbols | 6+ |
| | | sequence | Counters - | |
| | | | from board | |
| | | | game | |
| 7 | direction | Compass + map | Animal fact - | 6+ |
| | | | location/frame | |
| | | | direction | |
| 8 | time | clock | Animal fact - | 6+ |
| | | | newsflash | |
| 9 | measurement | Measurement | Animal fact - | 6+ |
| | | type | measurement | |

### Point Name Say and Play (PNSP) Educational Set

The frame design aims to provide parents a means of sharing their knowledge in educational fundamentals within a non-educational setting.

The name of the product effectively describes how it is used in a manner, which allows young children to learn with those who are familiar to them. Parents share this simple but effective learning tool with their children. Parents are encouraged to use the flash cards with the designated inserts, pointing out and naming objects for their children. Children are encouraged by the parents to say new words and terms and find objects on the frame. SKU is the acronym for shared knowledge unit; see the table listed above if unsure of what to introduce your child to next. Play is an essential part of learning. Use the game table shown below to introduce games that use components of the PNSP educational set.

### Components:

Shapes—there are eight shape cards, matching shapes on the frame, and colour/shape insert.

Colours—there eight colour cards, matching colours on the frame, and colour/shape insert.

Alphabet—there are twenty-six alphabet cards, depicting the animals on the frame and letters on the letters/numbers insert.

Numbers—there are twenty-six number cards, depicting the animals and shells on the frame and numbers on the letters/numbers insert.

Direction cards—there are twenty-six location/direction cards. Use the compass insert and removable point to practice direction recognition or an atlas to locate country of origin for each animal.

Newsflash cards—there are twenty-six newsflash cards with animal facts. Use the clock insert and removable hands to practice time recognition or create new newsflash cards to introduce minutes and learn more about each animal.

Measurement cards—there are twenty-six measurement cards. Use the measurement insert to identify measurement by type. Use scales, ruler and water jugs to practice measurement

Animal tales—there are twenty-six animal tale cards. Use these tongue twisters to “find” the individual letters, children will begin to understand that the words they see are written with the letters they know and said with the sounds that those letters represent.

The wording on two of the animal tales cards is nonconforming; when your child comments on the differences in spelling and initials it is time to introduce the thesaurus (B) and dictionary (K).

Symbol cards—there are twenty-six symbols depicted for you explain grammar and function. Children can be encouraged to write simple sentences about the animals depicted on the frame or make simple sums with the dice and tokens from the PNSP educational set. King of the jungle is a great game for practicing addition skills.

In addition, every PNSP educational set includes twelve moulded “player” tokens

Twenty-six animal trail cards.

Forty-eight marked counters

Two dice

Including these components allows the educational frame to become a family orientated board game.

Games

| | | | | Recom- |
|---|---|---|---|---|
| | | | | mended |
| Name | items | INSERT | CARDS | age |
| Where is it? | | Arajii animal | Shapes and | 3-4 |
| | | reserve | colours | Two players |
| Snap | | Arajii animal | Numbers and | 5-8 |
| | | reserve | alphabet | Two-four |
| | | | | players |
| Go Fish | | Arajii animal | Numbers and | Two + four |
| | | reserve | alphabet | players |
| Lonely lion | | Arajii animal | Numbers and | Two + four |
| | | reserve | alphabet | players |
| King of the | | Arajii animal | Numbers and | 8 + |
| jungle | | reserve | alphabet | Two-six |
| | | | | players |
| Animal | | Arajii animal | alphabet | 8 + |
| Charades | | reserve | | Two-26 |
| | | | | players |
| Arajii animal | 48 x item | Arajii animal | Alphabet | 8 + |
| reserve | tokens | reserve | animal trails | Two-six |
| | 6 x player | | animal tales | players |
| | tokens | | | |
| | 6 x canoe | | | |
| | tokens | | | |
| | 2 dice | | | |
| Memory | 4 x water | Arajii animal | | 6 + |
| | tokens | reserve | | Two players |
| | 4 x camera | | | |
| | tokens | | | |
| | 4 x hat tokens | | | |
| | 4 x stone | | | |
| | tokens | | | |

### Game Rules:

Where is it? Objective is to be the Fist to Lay Your Cards on the Frame

Play this game with the colour and shape cards. Shuffle all cards and deal out face down to each player. Players “race” to see who can place them on the matching square first.

Snap: Objective is to have all the Cards at the End of Play

Play this game with the alphabet and number cards. Shuffle the cards and deal all out face down to each player one by one in clockwise order.

Players take the top card from the pile in front of them (face down) and turns it face up on the arajii reserve insert. The player must not turn the active card face up until it is over Arajii Reserve—this ensures all players get to see the card at the same time.

The first player to yell “snap” (when the active card's animal matches the one on the centre pile) takes all cards from the centre and play resumes until one player is holding the all cards.

When no snaps occur, there is no winner. Reshuffle and deal the cards for the next game.

### Go Fish: Objective is to Collect the Most Pairs.

Play this game with the alphabet and number cards. Shuffle the cards and deal five cards to each player. Place the remainder of the deck face down on the Arajii animal reserve insert.

The active player asks the player on the left for an animal that matches one in their hand. If the player holds the requested card, they must give it to the active player. If the player does not hold the requested card, they must tell the active player to “go fish”.

When the active player is given a card, they place the “pair” face up on the frame in front of them and have another turn.

When the active player is told to “go fish”, they take a card from the pile face down on the reserve

It is then the next players turn.

### Lonely Lion (Similar Rules as Old Maid): Objective is to be the Player Holding the Lion Card at the End of the Game

Play this game with the alphabet and number cards. Remove the number 12 card (lions). Shuffle the cards and deal all out face down to each player one by one in clockwise order. It does not matter if players end up with more cards than others do.

The players look at their hands and throw matching pairs (same animals depicted) face down on the arajii animal reserve. The first player offers remaining cards, fanned out and face down the player on the left. The player must take a card and adds it to their hand. If it makes a pair, the new player discards the pair before offering his/her cards in the same way to the player on the left. Eventually all bar the lion card will be paired. The holder of this card wins the round.

### King of the Jungle: Objective is to be the First Player to Make 100 Points.

Play this game with the alphabet and number cards. Dealer uses pen and pad to score and tally players points (including their own). Shuffle the cards and deal five cards to each player in clockwise order.

Players look at their cards and lay any they do not want face down on the arajii animal reserve—the dealer collects these cards, reshuffles the deck and gives each player the corresponding number of cards so that each player again holds five cards. In clockwise order, players lay their cards face up on the table and declare the total of the number cards they are holding (calculators permitted) Alphabet cards have no value in this game—Number cards are of face value e.g.: 1 is worth 1 point and 26 is worth 26 points. The first player to reach 100 points is the king of the jungle.

### Animal Charades: Objective is to Guess the Animal as Quickly as Possible.

Use the alphabet, direction and news flash cards to play this game. Match up the three cards by animal and place sets face down on the frame. Each player draws one set of cards and keeps them away from other players. In clockwise order, players mime or use the direction/newsflash cards to describe and hint as to what animal card they hold. The winner of the round is the first to name what the animal is. The winner of the game names two animals in a row.

Memory: Objective is to have the Most Pairs

Use 6 of each token type to play this game. Lay the tokens face down, in a pattern (e.g. 4 tokens×6 tokens). The first player turns over two tokens (one at a time) and removes them from the frame when they match. If a player matches two tokens, they take another turn. If the two turned tokens do not match, they are turned back over and it becomes the next player's turn.

Players keep matching tokens. The game ends when all tokens are gone from the frame. The player with the most tokens wins.

Arajii animal reserve is a fantasy reserve where animals can live without risk of extinction from deforestation, hunting or global warming. To be a place getter in the arajii animal reserve game you must collect three items, transfer to a canoe and land on a corresponding coloured anchor point.

### Set Up

Position the frame and game board insert face up on a table
Shuffle and place the alphabet cards face down in a central area of the frame
Line the player tokens up in front of the alphabet cards
Shuffle and place the animal Tales cards face down on the reserve
Shuffle and place the animal trails cards face down on the reserve

### Before Play

Choose a moderator for the game
The moderator for each game is responsible for the giving out and collection of tokens. The moderator resolves disputes by referring to the rules.
Each player collects an alphabet card and player token from the frame
The alphabet card represents the animal protected by the player for the game and is placed face up in front of the player
The player token represents the player during the game and is placed on the “albatross” (start).
   Decide whether the “house rule” will be applied to the current game.
Rule five is a house rule. Remove the “animal tales” cards from the reserve before beginning the game when this rule is not in force.

### Determining Who Goes First

The player who's animal card is closest to Z goes first

### Tokens Used During Play

Camera—must have before switching to canoe token
Hat—must have before switching to canoe token
Water—must have before switching to canoe token
Free step—this token is used to move one square forward or one square back.
Boat—switched to from player token to enter “water” area of frame

### Squares of Significance During Game Play

Northern lights (North)=go to the animal you are protecting
Southern lights (South)=collect free step
Sunrise (East)=roll dice and move forward corresponding number of squares
Sunset (West)=roll dice and move back corresponding number of squares
Protected animals=collect a token from any player who lands on the animal in your protection.
Green stones—collect a jungle trail card and carry out instructions
Yellow stones—quote a jungle tale card for a token of choice

### Arajii Animal Reserve Rules

1. Players must move in a clockwise direction
2. players must take turns in a clockwise direction
3. Players must start the game from the Albatross
4. Players must end the game by landing their boat token on the corresponding coloured anchor point
5. *Players must collect an Animal tales card when landing on a yellow stone square and loudly call out the sentence for a token of their choice
6. Players must collect an animal trails card when landing on a red stone square and carry out instructions
7. Players must request a token from any player who lands on the animal in their protection before the next player rolls the dice
8. Players must surrender their tokens when required by game rules
9. Players who do not have a token to surrender must return to the albatross square
10. Moderator must exchange a token for any player who holds three of the same item tokens when requested
11. Players landing on a feature square by means of a dice roll or jungle trails card must carry out the instructions associated with that square.
12. Players must declare they need a canoe on the collection of the three item tokens, camera, hat and water as soon as the third token is collected
13. The moderator must place a canoe token of the same colour on the sand square in front of the player token who has requested it and remove the corresponding player token
14. Players must traverse the sand and enter the water area of the frame from the opposite side to the which the animal in their protection is located
15. Players must land on the corresponding coloured anchor closest to the animal in their protection

### * Replacement Rule for Rule Five

Players collect an item of choice when landing on a yellow stone square.
Long play—allow all players to “place”
Short play—be the first player to get to the anchor point on arajii animal reserve.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

1. An educational tool for teaching a user, the tool including:
i. At least one first member having a plurality of different visual cues;
ii. At least one second member separate from but useable with the at least one first member by location of the at least one second member within the boundary of the at least one first member on an upper side of the at least one first member, the at least one second member having a plurality of indicia, each indicia corresponding to at least one visual cue on the at least one first member;
wherein indicia of the at least one second member are used in increasing levels of difficulty, to trigger the user to associate and identify indicia on the at least one second member with a corresponding visual cue on the at least one first member.

2. An educational tool as claimed in claim 1 wherein each at least one first member is a mat.

3. An educational tool as claimed in claim 1 wherein each at least one first member has two substantially planar surfaces, each having visual cues such that either planar surface can be oriented upwards in use.

4. An educational tool as claimed in claim 1 wherein the visual clues are located in a first group in a band located adjacent to and extending around the periphery, and in a second group located between the at least one second member and the first group.

5. An educational tool as claimed in claim 1 wherein the at least one first member is formed from a plurality of pieces each piece having at least one indentation, therein to receive the at least one second member.

6. An educational tool as claimed in claim 1 wherein the at least one first member is formed from a plurality of pieces and the pieces are connected to each other by means of an engagement plate.

7. An educational tool as claimed in claim 1 wherein the at least one second member is a planar member, having two planar surfaces, an upper and a lower surface, each planar surface having indicia thereon.

8. An educational tool as claimed in claim 5 wherein the at least one second member is an island portion adapted to fit into the indentation of the at least one first member.

9. An educational tool as claimed in claim 1 further including cards, including colour cards, shape cards, number cards, maths sign cards and alphabet cards; tokens, including tokens of different colours and shapes; chips; instruction cards; consignment cards; at least one die; and hour and minute hands.

10. A method of teaching a user increasing levels of difficulty including the steps of:
i. Providing an educational tool for teaching a user, the tool including at least one first member having a plurality of different visual cues and at least one second member associated with the at least one first member, the at least one second member having a plurality of indicia, each indicia corresponding to at least one visual cue on the at least one first member;
ii. Using the at least one second member to trigger the user to associate indicia on the at least one second member with a corresponding visual cue on the at least one first member.

11. A method of playing a game including the steps of:
i. Providing a tool for entertainment of a user, the tool including at least one first member having a plurality of different visual cues and at least one second member associated with the at least one first member, the at least one second member having a plurality of indicia, each indicia corresponding to at least one visual cue on the at least one first member;
ii. Using the at least one second member to trigger the user to associate indicia on the at least one second member with a corresponding visual cue on the at least one first member.

12. A method as claimed in claim 10 wherein the tool includes a number shape cards, each shape card having one shape on the face of the card, each shape also represented at least once on the at least one first member and wherein a first level of difficulty is teaching the user to find and name shapes on the at least one first member that match the shape on the face of a selected shape card.

13. A method as claimed in claim 12 wherein the tool further includes a number of colour cards, each colour card having at least one colour on the face of the card, that colour also represented on the at least one first member at least once and wherein a second level of difficulty is teaching the user to find and name colours on the at least one first member that match the colour on the face of a selected colour card.

14. A method as claimed in claim 13 wherein a third level of difficulty is teaching the user to find and name colours on the at least one first member that are created by a combination of the colours on the faces of two or more selected colour cards.

15. A method as claimed in claim 14 wherein the tool further includes a number of alphabet cards, each alphabet card having at least one letter on the face of the card, that letter also represented on the at least one first member at least once and wherein a fourth level of difficulty is teaching the user to find and name the letter on the at least one second member that matches the letter on the face of a selected alphabet card.

16. A method as claimed in claim 15 wherein a fifth level of difficulty is teaching the user to find and name a picture or image on the at least one first member where the first letter in the name of the object of the picture or image on the at least one first member matches the letter on the face of a selected alphabet card.

17. A method as claimed in claim 16 wherein the tool further includes a number of “number” cards, each number card having at least one number on the face of the card, that number also represented on the at least one first member, and wherein a sixth level of difficulty is teaching the user to identify the number of a particular type of thing represented on the at least one first member that matches the number on the face of a selected number card.

18. A method as claimed in claim 17 wherein a seventh level of difficulty is teaching the user to name all of the numbers on the number cards and to put the number cards in ascending or descending order.

19. A method as claimed in claim 18 wherein the tool further includes a number of maths sign or symbol cards and wherein a tenth level of difficulty is teaching the user to find a maths card and use the maths card in combination with at least one of other cards, the at least one first member or the at least one second member to trigger mathematical combinations.

20. A method as claimed in claim 19 wherein an eleventh level of difficulty is teaching the user to perform mathematical calculations created by two or more selected number cards and one or more selected maths sign cards.

21. A method as claimed in claim 20 wherein the tool further includes at least one compass rose on at least one of the planar surfaces and wherein an eighth level of difficulty is teaching the user to identify compass points on the at least one compass rose using one or more cards with directions indicated thereon.

22. A method as claimed in claim 21 wherein a ninth level of difficulty is teaching the user to name the direction on the compass rose.

23. A method as claimed in claim 22 wherein the at least one first member includes a clock face having an indentation at the centre, providing hour and minute hands having projections which fit into the indentation and wherein a twelfth level of difficulty is teaching the user to name the time indicated by the hour and minute hands using one or more prompt cards to identify a time to be set.

24. A method as claimed in claim 23 wherein the tool further includes a number of consignment cards and a thirteenth level of difficulty is teaching the user to relate the time indicated by the hour and minute hands on the clock face to periods of time indicated on some of the consignment cards.

25. A method as claimed in claim 24 wherein the tool further includes a number of chance cards having a picture of an animal surrounded by a number of words and wherein a fourteenth level of difficulty is teaching the user to select descriptive words from the number of words surrounding the animal on the face of a selected chance card.

26. A method as claimed in claim 25 wherein a fifteenth level of difficulty is teaching the user to ascertain a meaning of the descriptive words in a dictionary and thesaurus.

27. A method as claimed in claim 30 wherein the levels of difficulty are taught in a graduated manner with a user required to master one level prior to progressing to the next level.

28. A method as claimed in claim 26 wherein the levels of difficulty are used to identify the developmental level of the user in an evaluation mode where the user is subjected to the levels of difficulty in either forward or reverse order until all are complete or until a user cannot perform a level of difficulty.

29. A method as claimed in claim 11 wherein the tool includes a number shape cards, each shape card having one shape on the face of the card, each shape also represented at least once on the at least one first member and wherein a first level of difficulty is teaching the user to find and name shapes on the at least one first member that match the shape on the face of a selected shape card.

30. A method as claimed in claim 29 wherein the tool further includes a number of colour cards, each colour card having at least one colour on the face of the card, that colour also represented on the at least one first member at least once and wherein a second level of difficulty is teaching the user to find and name colours on the at least one first member that match the colour on the face of a selected colour card.
